(19) United States
(12) Patent Application Publication
(10) Pub. No.: US 2025/0345793 A1
(43) Pub. Date: Nov. 13, 2025

(54) INTERFACIAL ENHANCEMENT OF ELECTROSTATIC FIELD FOR DROPLET TRAPPING AND INTERFACE LOCALIZATION

(71) Applicants: The University of Hong Kong, Hong Kong (CN); Advanced Biomedical Instrumentation Centre Limited, Hong Kong (CN)

(72) Inventors: Ruotong Zhang, Hong Kong (CN); Ho Cheung Shum, Hong Kong (CN); Haisong Lin, Hong Kong (CN)

(21) Appl. No.: 19/201,496

(22) Filed: May 7, 2025

Related U.S. Application Data
(60) Provisional application No. 63/644,182, filed on May 8, 2024.

(51) Int. Cl. B01L 3/00

(52) U.S. Cl. CPC B01L 3/50273; B01L 3/502715; B01L 3/502761; B01L 2300/0816; B01L 2400/0424

(57) ABSTRACT

Electrostatic field devices that include an electret and a dielectric mask are described herein. At least two dielectric materials in the dielectric mask have different relative permittivity, which are arranged such that one or more interfaces are formed therebetween. The devices surprisingly generate a local maximum of electrostatic field at and/or near the interface(s) formed between the dielectric materials having different relative permittivity. Such local maxima of the electrostatic field can polarize and attracts one or more objects, such as one or more droplets to move to the local maximum of electrostatic field and get trapped. The trapping of the object(s) can thus indicate the position of the interface(s) between the dielectric materials having different relative permittivity in the dielectric mask, providing a simple way for low-energy interface localization.

### CROSS-REFERENCE TO RELATED APPLICATIONS

This application claims the benefit of and priority to U.S. Provisional Application No. 63/644,182 filed May 8, 2024, which is herein incorporated by reference in its entirety.

### FIELD OF THE INVENTION

The disclosed invention is generally in the field of electrostatic field devices and methods of use thereof.

### BACKGROUND OF THE INVENTION

Programmed and versatile liquid manipulation is useful in a wide range of applications from microfluidics to combinatorial chemistry. Various platforms, such as light, electric, thermal, magnetic, and topological anisotropies, have been used to actuate droplets on superwetting surfaces. For example, Wang et al., Sci. Adv. 2019, 5, eaau8769 reported a method for patterning liquids by using the capacitor edge effect. However, this method requires the use of a capacitor composed of a conductive metal and two electrodes, and a continuous supply of energy to power the capacitor, which raised the energy needed and the cost of the device.

Devices using electrostatic field for liquid manipulation were recently reported. Contrary to most previous active strategies related to electric or magnetic fields, this technique does not need extra particles or electrodes. For example, Han et al., J. Am. Chem. Soc. 2023, 145, 6420-6427 reported a charge shielding mechanism (CSM) to manipulate liquids versatilely in a noncontact manner by local potential gradients. However, this method also requires the use and physical movement of a conductive metal to achieve the charge shielding effect, which raised the cost and complexity of the device.

There remains a need to develop devices and methods for manipulating an object, such as a liquid, that are simple and at lower cost, such as lower energy cost.

Therefore, it is the object of the present invention to provide electrostatic field devices.

It is a further object of the present invention to provide methods of using the electrostatic field devices.

### SUMMARY OF THE INVENTION

Electrostatic field devices (also referred to herein as “devices”) are described herein. The devices include an electret and a dielectric mask. The dielectric mask of the device contains two or more dielectric materials. At least two of the two or more dielectric materials in the dielectric mask have different relative permittivity. The at least two dielectric materials having different relative permittivity in the dielectric mask are arranged such that one or more interfaces are formed therebetween.

The electret and dielectric mask are arranged such that a first surface of the dielectric mask is in parallel and aligns with at least a portion of a first surface of the electret. For example, a first surface of the dielectric mask is in parallel and aligns with a first surface of the electret. The electret and dielectric mask may be in physical contact with each other, or be kept at a distance from each other. In some forms, the electret and dielectric mask of the device are kept at a distance from each other.

The electret in the device carries intrinsic electrostatic charges that generate an approximately uniform electrostatic field. The lines of the electrostatic field are refracted to varying degrees as they pass through the dielectric materials having different relative permittivity in the dielectric mask, which surprisingly results in a local maximum of electrostatic field at and/or near the interface(s) formed between the dielectric materials having different relative permittivity. It is believed that this is the first discovery of the formation of a local maximum of electrostatic field, which, when used in a suitable device, allows for simple, low-energy objects manipulation and interface localization.

Optionally, the devices further include one or more objects, such as one or more droplets and/or one or more solid particles, placed on a surface of a substrate. When a substrate containing one or more objects is included in the device, a second surface of the dielectric mask that is opposite to the first surface of the dielectric mask is in parallel and aligns with the surface of the substrate that has the one or more objects placed thereon. Typically, the dielectric mask has a size that is larger than the area of the subject for objects actuation. For example, the dielectric mask has a length that is longer than the length of the substrate. For example, the interface on the dielectric mask has a length that is longer than the length of the substrate.

The one or more objects in the device can visualize the local maximum of electrostatic field at and/or near the interface(s) using electrostatic polarization effect. For example, the electrostatic field at the interface of dielectric materials having different relative permittivity in the dielectric mask can be locally enhanced due to the refraction of electrostatic field line. The local maxima of the electrostatic field can then polarize and attracts the one or more objects in the device to move to the local maximum of electrostatic field and get trapped. The trapping of the object(s) can thus indicate the position of the interface(s) between the dielectric materials having different relative permittivity in the dielectric mask, providing a simple way for low-energy interface localization.

### BRIEF DESCRIPTION OF THE DRAWINGS

FIGS. 1A-1E illustrate the working principle of interfacial enhancement of electrostatic field on an exemplary device for droplet trapping and interface localization. FIG. 1A is a schematic diagram illustrating the experimental setup, including a piece of electret carrying intrinsic electrostatic charges to generate an approximately uniform electrostatic field, a thin layer of dielectric mask in which two materials with different permittivity (ε₁, ε₂) forms interfaces, and a droplet. FIG. 1B shows the simulation result of the distribution of electrostatic field near the interface, indicating that the lines of the electrostatic field were refracted to varying degrees as they passed through the two media with different permittivity (ε₁, ε₂), resulting in a local maximum of electrostatic field (E₂, ∇E²=0) near the interface. FIG. 1C shows the simulated electrostatic field strength and the measured variation of electric potential, demonstrating that electrostatic field was locally enhanced near the interface between ε₁ and ε₂. FIG. 1D are optical images showing that droplets were attracted and trapped by the local maximum of electrostatic field near the interface. FIG. 1E shows the simulated Maxwell stress tensor generated on droplet with different locations, demonstrating that droplet got trapped at the force equilibrium point (F=0) near the interface, and thereby localizing the interface between ε₁ and ε₂.

FIGS. 2A-2H show the characterization of droplet trapping based on interfacial enhancement of electrostatic field on the exemplary device illustrated in FIG. 1A. FIG. 2A shows the real time position and velocity of droplets during the trapping process. The results demonstrate that both droplets starting from area beneath &1 and 82 were trapped near the interface eventually. FIG. 2B shows the relationship between effective actuation distance and the charge density of electret, showing that as charge density carried by the electret increased, droplets located further away got attracted by the enhancement of the local field strength generated at the interface. FIG. 2C shows the relationship between average force for droplet trapping and charge density of the electret. FIG. 2D shows the relationship between average force for droplet trapping and different droplet volume. FIG. 2E shows trapping of droplets of different liquids, including inorganic liquids, such as water, H₂O₂, HCl, and organic liquids, such as glycerol, paraffin, triacetin, demonstrating the compatibility of the method with droplet liquid types. FIG. 2F shows the relationship between average force for droplet trapping and different interfaces: water-air, HFE oil-air, and paraffin-air. FIG. 2G shows the simulated Maxwel stress tensor applied on droplet by different interfaces. FIG. 2H shows the relationship between average force for droplet trapping and different interfaces between water-air, water-paraffin, and water-HFE.

FIGS. 3A-3E show exemplary applications of the device for trapping multiple droplets, interface localizing, and detecting multiple buried defects in objects. FIG. 3A is a schematic diagram of the detected objects (ε₂) with multiple buried defects made of different materials (ε₁), sandwiched by two barriers. FIG. 3B is a heat map of the simulation results of the electric field strength beneath the detected objects (ε₂. The results show that multiple Eₘₐₓ exists at the interface of each defect (ε₁), providing the foundation for electrolocation of multiple defects. FIG. 3C shows optical images of the mechanosensory droplets (D1-D6) at the beginning and after placing three different detected objects in sequential, recorded from the bottom angle. Scale bars, 15 mm. FIGS. 3D-3E show real time positions of the mechanosensory droplets in x- (FIG. 3D) and y- (FIG. 3E) directions, which change immediately after placing each detected object in interfacial enhancement of electrostatic field, showing its ability for detecting multiple buried defects in sequence.

FIGS. 4A-4F show active droplet actuation and localization of the moving interface. FIG. 4A is a schematic diagram of the experimental setup, where a microfluidic chip full of water (ε₂) was used to generate a movable interface by continuously injecting air (ε₁) into it. FIG. 4B shows the simulation of electrostatic field strength near the moving interface, where the calculated Maxwell stress tensor indicates that the droplet was trapped by the moving interface. FIG. 4C are optical images showing the active droplet actuation with the moving interface. FIG. 4D shows the real time position of the droplet and interface, demonstrating that the droplet moved along with the interface and thereby located the moving interface. FIG. 4E are optical images showing the active droplet actuation with a fast-moving interface. FIG. 4F shows the real time position of droplet and interface, demonstrating that droplet got lost if the speed of the moving interface is too fast.

FIGS. 5A-5G show the application of the device for locating general uncharged target objects in the air. FIG. 5A is a schematic diagram of the interfacial enhancement of electrostatic field device for locating objects in the air, which contains an electret, target object, and mechanosensory structure made of droplet. FIGS. 5B-5C are sequential optical images of the device's working process for locating a stationary object, recorded from the bottom angle. Dash line: boundary of the target object. Scale bars, 3 mm. The mechanosensory droplet moves towards the object boundary from the space beneath either the target object (FIG. 5B) or the air surroundings (FIG. 5C). FIG. 5D shows sequential optical images of the device's working process for locating a moving solid object, recorded from the bottom angle. Dash line: boundary of the target object. Scale bars, 3 mm. FIG. 5E shows sequential optical images of the device's working process for locating a moving liquid object, recorded from the bottom angle. Dash line: boundary of the target object. Scale bars, 3 mm. FIG. 5F-5G are graphs of the mechanosensory droplet location (mm) over time (sec.) and velocity of the droplet (mm/sec.) as it moves towards the object boundary from the space beneath either the target object (FIG. 5F) or the air surroundings (FIG. 5G). Red solid line: location of the mechanosensory droplet in the x direction. Blue solid line: velocity of the mechanosensory droplet in the x direction.

FIGS. 6A-6D show the application of the device for locating defects in objects. FIG. 6A is a schematic diagram of the interfacial enhancement of electrostatic field device for locating defects (ε₁) in objects (ε₂). FIG. 6B shows overlaid sequential optical images to demonstrate the device's application for locating different defects in different objects. Scale bar: 3 mm. FIG. 6C is a bar graph showing the calculated average force applied on the mechanosensory droplet when locating the defects (ε₁) in objects (ε₂=78.4). FIG. 6D is a schematic diagram of the side view of interfacial enhancement of electrostatic field device.

### DETAILED DESCRIPTION OF THE INVENTION

### I. Devices

Described are electrostatic field devices (also referred to herein as “devices”). The devices include an electret and a dielectric mask. The dielectric mask of the device contains two or more dielectric materials. At least two of the two or more dielectric materials in the dielectric mask have different relative permittivity. The at least two dielectric materials having different relative permittivity in the dielectric mask are arranged such that one or more interfaces are formed therebetween. For example, the dielectric mask of the device contains two different dielectric materials having different relative permittivity, and the two dielectric materials in the dielectric mask are arranged such that one or more interfaces are formed between the two dielectric materials on the dielectric mask.

The electret and dielectric mask are arranged such that a first surface of the dielectric mask is in parallel and aligns with at least a portion of a first surface of the electret. For example, a first surface of the dielectric mask is in parallel and aligns with a first surface of the electret. The electret and dielectric mask may be in physical contact with each other, or be kept at a distance from each other. In some forms, the electret and dielectric mask of the device are kept at a distance from each other. In these forms, the distance between the electret and dielectric mask that are in parallel with each other can be generally in a range from 0.05 mm to <0.5 mm, from 0.1 mm to <0.5 mm, or from 0.15 mm to <0.5 mm, such as about 0.17 mm.

The electret in the device carries intrinsic electrostatic charges that generate an approximately uniform electrostatic field. The lines of the electrostatic field are refracted to varying degrees as they pass through the dielectric materials having different relative permittivity in the dielectric mask, which surprisingly results in a local maximum of electrostatic field at and/or near the interface(s) formed between the dielectric materials having different relative permittivity. It is believed that this is the first discovery of the formation of a local maximum of electrostatic field, which, when used in a suitable device, allows for simple, low-energy objects manipulation and interface localization.

Optionally, the devices further include one or more objects, such as one or more droplets and/or one or more solid particles, placed on a surface of a substrate. When a substrate containing one or more objects is included in the device, a second surface of the dielectric mask that is opposite to the first surface of the dielectric mask is in parallel and aligns with the surface of the substrate that has the one or more objects placed thereon. Typically, the dielectric mask has a size that is larger than the area of the subject for objects actuation. For example, the dielectric mask has a length that is longer than the length of the substrate. For example, the interface on the dielectric mask has a length that is longer than the length of the substrate.

The one or more objects in the device can visualize the local maximum of electrostatic field at and/or near the interface(s) using electrostatic polarization effect. For example, the electrostatic field at the interface of dielectric materials having different relative permittivity in the dielectric mask can be locally enhanced due to the refraction of electrostatic field line. The local maxima of the electrostatic field can then polarize and attracts the one or more objects in the device to move to the local maximum of electrostatic field and get trapped. The trapping of the object(s) can thus indicate the position of the interface(s) between the dielectric materials having different relative permittivity in the dielectric mask, providing a simple way for low-energy interface localization.

In some forms, the device can include an electret as a first component, a dielectric mask as a second component, and optionally a substrate containing one or more objects as a third component; however, it does not include any conductive metal as a separate component. In these forms, a conductive metal may be still used in the dielectric mask to form interface(s) with one or more other materials that have a relative permittivity different from the conductive metal.

In some forms, the device does not include a conductive material that is in contact with a surface of the electret that is opposite to the surface of the electret facing the dielectric mask.

### A. Electret

The device includes an electret. The electret can be formed using any suitable material, as long as it can carry intrinsic electrostatic charges to generate an approximately uniform electrostatic field. Examples of material suitable for forming the electret of the device include, but are not limited to, silicon dioxide, or a polymer, or a combination thereof. Examples of polymers suitable for forming the electret of the device include, but are not limited to, fluorinated polymers, such as polytetrafluoroethylene (PTFE), fluorinated ethylene propylene (FEP), Teflon AF, trifluoromethyl (CTL-S), carboxyl (CTL-A), amidosilyl (CTL-M), etc.

When in use, the electret of the device has a suitable charge density. Typically, the charge density of the electret of the device is sufficient to produce a force that moves the one or more objects toward a location on the substrate that aligns with an interface between dielectric materials having different permittivity in the dielectric mask. For example, when in use, the electret of the device has a charge density of at least-4 μC/m², such as a charge density ranging from −4 μC/m² to 2 mC/m². In some forms, the electret may also have a high charge stability. For example, the change of the charge density of the electret is less than 30%, less than 20%, or less than 10% for at least a few minutes (e.g., at least 2 mins, at least 5 mins, at least 10 mins, at least 30 mins, at least 1 hour, at least 2 hours, at least 3 hours, at least 5 hours, etc.), at least a few days (e.g., at least 2 days, at least 3 days, at least 5 days, at least 7 days, etc.), or a few weeks (e.g., at least 2 weeks, at least 3 weeks, at least 4 weeks, at least 5 weeks, at least 6 weeks, etc.).

The electret can have any suitable size and shape, as long as an approximately uniform electrostatic field can be generated, covering the entire surface of the dielectric mask. For example, the electret has a regular shape, such as the shape of a rectangle, a circle, a square, etc. or an irregular shape. The size and/or shape of electret and dielectric mask may be the same or different, as long as the size of the electret is larger than the actuation range of the objects, such as the droplet actuation range.

### B. Dielectric Mask

The device includes a dielectric mask positioned beneath the electret. Typically, the electret and dielectric mask are arranged such that a first surface of the dielectric mask is in parallel and aligns with at least a portion of a first surface of the electret. For example, a first surface of the dielectric mask is in parallel and aligns with a first surface of the electret. The electret and dielectric mask may be in physical contact with each other, or be kept at a distance from each other. In some forms, the electret and dielectric mask of the device are kept at a distance from each other, where the distance can range from 0.05 mm to <0.5 mm, from 0.1 mm to <0.5 mm, or from 0.15 mm to <0.5 mm, such as about 0.17 mm.

The electret and dielectric mask of the device can be kept at a distance using any suitable means, such as by placing a separating layer between the electret and dielectric mask. Additionally or alternatively, the device can contain a supporting mean that allows the electret and dielectric mask to be placed thereon and thus physically separate the two in the device. For example, a two-layer shelf is included in the device to hold the electret and the dielectric mask at different heights above a substrate on which the objects, such as droplets, were placed.

### 1. Separating Layer

When a separating layer is used in the device to keep the electret and dielectric mask at a distance from each other, the electret and/or the dielectric mask may be in physical contact with the separating layer. Optionally, the separating layer is configured to be in direct contact with the dielectric mask, while not contacting the surface of the electret.

The one or more separating layers can have any suitable arrangements and orientations relative to the dielectric mask and the electret. In some forms, one or more separating layers are positioned between the dielectric mask and object(s), such as droplet(s), placed on a surface of the substrate. Additionally or alternatively, one or more separating layers are positioned between the dielectric mask and the electret.

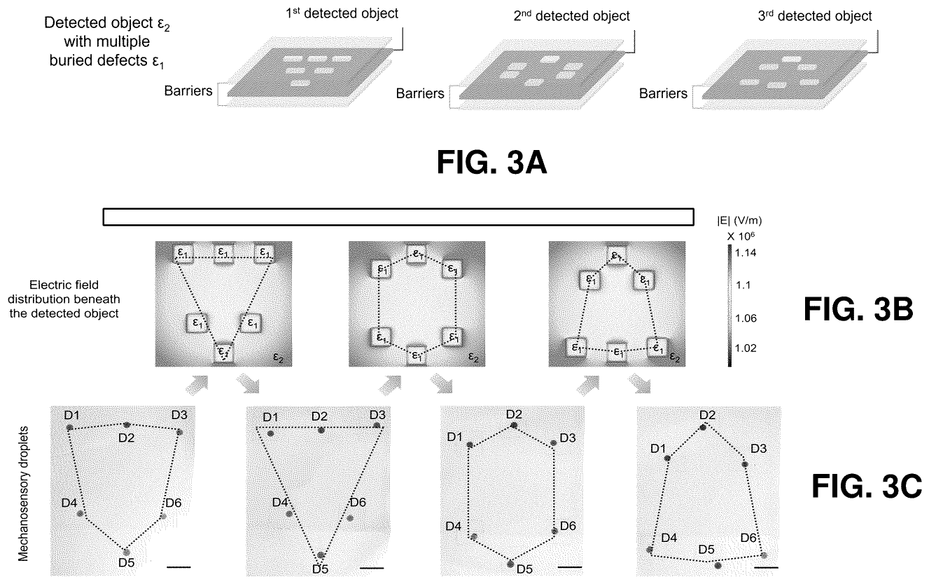

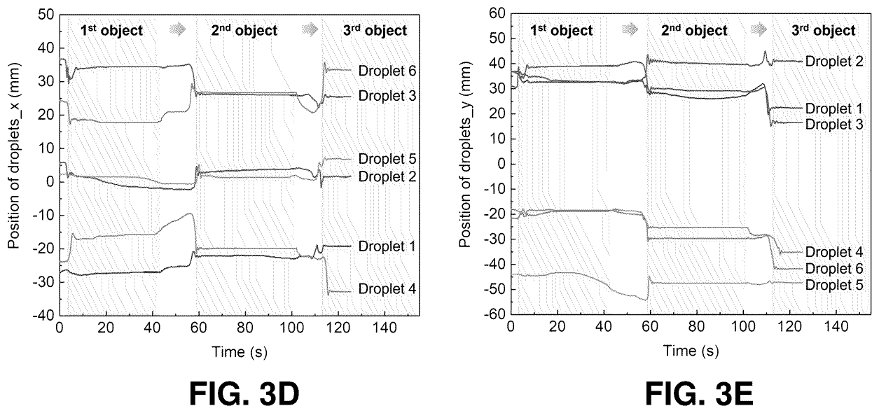

In some forms, the one or more separating layers are positioned on one or both sides of the dielectric mask and have any suitable orientations, as long as they separate the dielectric mask from the electret and/or the objects, and optionally bury any defects in the dielectric mask. For example, two separating layers are positioned on two sides of the dielectric mask, where a first separating layer is on top of the dielectric mask and a second separating layer is beneath the dielectric mask. Optionally, each of the separating layers aligns with the dielectric mask. For example, as shown in FIG. 3A, the dielectric mask is in parallel and sandwiched in between a first and a second separating layer.

For example, in the device, a separating layer is placed in between the electret and dielectric mask such that the electret and dielectric mask are kept at a distance from each other, where a surface of the dielectric mask is in contact with a first surface of the separating layer, and a surface of the electret is in contact with a second surface of the separating layer, where the first surface is in parallel with and opposite to the second surface of the separating layer.

For example, the device includes two separating layers. A first separating layer is placed in between the electret and the dielectric mask, where a first surface of the dielectric mask is in contact with a first surface of the first separating layer, and a surface of the electret is not in contact with and placed at a distance from a second surface of the first separating layer, where the first surface of the first separating layer is in parallel with and opposite to the second surface of the first separating layer. A second separating layer is placed in between the dielectric mask and a substrate where the objects are placed thereon, where a second surface of the dielectric mask that is opposite to the first surface of the electric mask is in contact with a first surface of the second separating layer, and the surface of the substrate on which the objects are placed is not in contact with and placed at a distance from a second surface of the second separating layer, where the first surface of the second separating layer is in parallel with and opposite to the second surface of the second separating layer.

The separating layers are generally in parallel and optionally align with at least a portion of the surfaces of the dielectric mask. For example, the surface of a first separating layer and optionally the surface of a second separating layers (when present) that are in contact with the dielectric mask are in parallel with the surfaces of the dielectric mask with which they contact and covers at least a portion, optionally the entire surface of the dielectric mask with which they contact (see, e.g., FIG. 3A).

In some forms, the separating layers are in parallel and optionally align with at least a portion of the electret and/or the substrate. For example, a first surface of a first separating layer positioned between the electret and dielectric mask is in parallel and optionally aligns with at least a portion of a first surface of the electret facing the dielectric mask, and a second surface of the first separating layer that is opposite to the first surface is in parallel with and aligns with a first surface of the dielectric mask. For example, a first surface of a second separating layer positioned between the substrate and dielectric mask is in parallel and optionally aligns with at least a portion of a first surface of the substrate facing the dielectric mask, and a second surface of the second separating layer that is opposite to the first surface is in parallel and aligns with a second surface of the dielectric mask that is opposite to the first surface of the dielectric mask.

Optionally, when one or more separating layers are included in the device, the separating layer(s) also serve(s) to “bury” one or more interfaces or defects in the dielectric mask, such that they are not visible or apparent to the user during operation. For example, the detected interfaces or defects of the dielectric mask can be “buried” by the separating layers. “Buried” interfaces or defects of the dielectric mask are hidden, unknown, and/or not in view for the person utilizing the device. By employing one or more objects, for example, droplets, the device is capable of detecting one or more buried interfaces or defects in the dielectric mask.

The separating layer can be formed using any suitable materials, as long as the material is not electrically conductive. In some forms, the separating layer is uncharged or carries only a small, uniformly distributed charge to avoid disrupting the electrostatic field generated by the electret and to ensure consistent field interactions with the dielectric mask. For example, a plastic material, such as polyethylene terephthalate (PET) or polymethyl methacrylate (PMMA), can be used to form the separating layer of the device. When the separating layer of the device is a PET separating layer, an uncharged PET virgin material was used. PET does not conduct electricity and therefore does not conduct away the charge on the electret and distribute it evenly over the entire surface. Further, PET can be easily machined by laser cutting, etc., to form a very thin layer. In some forms, the separating layer can have a thickness ranging from of about 0.10 mm to about 0.40 mm, such as about 0.17 mm, about 0.20 mm, or, about 0.30 mm. For example, in an exemplary device, a 0.17 mm-thick PET sheet is used as the top cover of the dielectric mask, and then an electret is directly placed on the PET sheet. Thus, the distance between electret and the dielectric mask (also the interfaces provided on the dielectric mask) is 0.17 mm.

### 2. Dielectric Materials

The dielectric mask of the device contains two or more dielectric materials. At least two of the two or more dielectric materials in the dielectric mask have different relative permittivity. The difference in relative permittivity of the at least two dielectric materials in the dielectric mask is sufficiently large to produce a local maximum of electrostatic field at and/or near the interface(s). For example, the difference in relative permittivity of two dielectric materials in the dielectric mask can be ≥1, ≥1.2, ≥1.5, ≥1.8, ≥2.0, or ≥2.2.

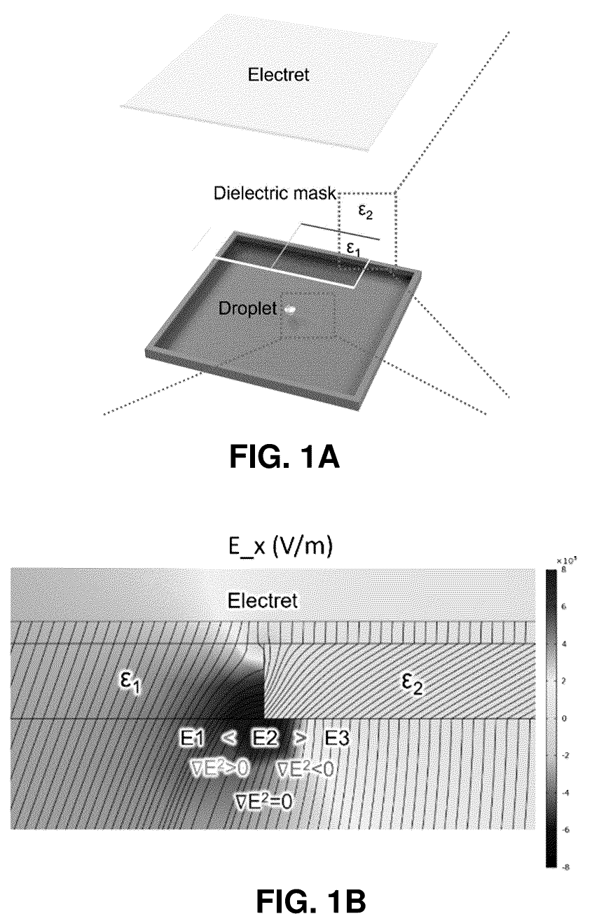

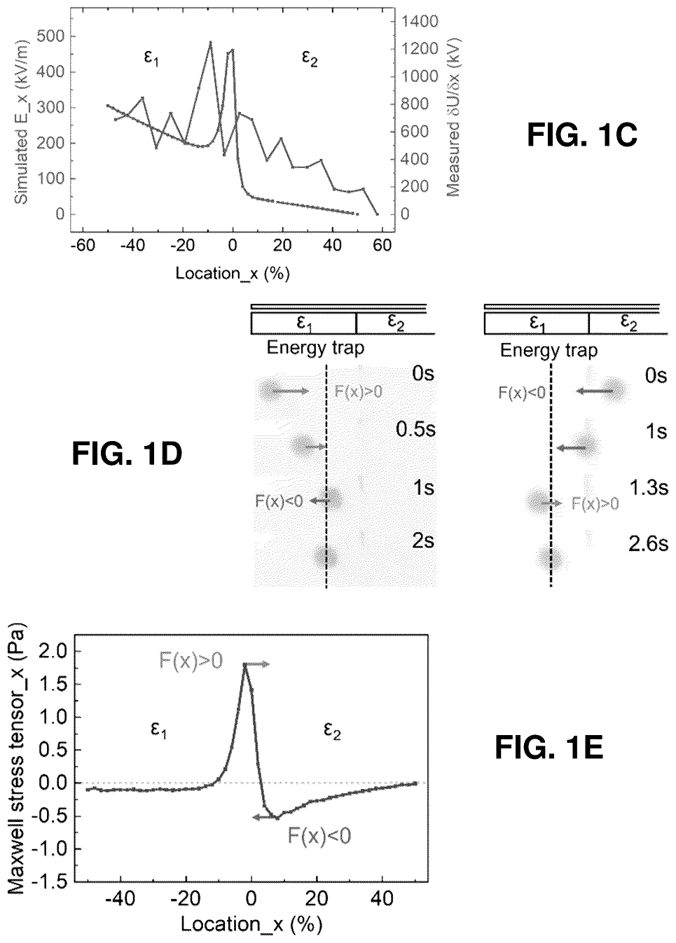

The dielectric materials having different relative permittivity in the dielectric mask are arranged such that one or more interfaces are formed therebetween. In some forms, the dielectric mask contains a base, on which two or more dielectric materials having different permittivity are arranged to form one or more interfaces. Examples of materials suitable to form the base of the dielectric mask include, but are not limited to, polydimethylsiloxane, polyethylene terephthalate (PET), polymethyl methacrylate, etc. When a base is included in the dielectric mask, a desired pattern may be incorporated on a surface of the base, such that each dielectric material can be simply added into a designated pattern to form one or more interfaces. The pattern can be produced using any suitable methods, and typically selected based on the dielectric materials used. For example, as shown in FIG. 1a, if liquids are used as the dielectric material, the base with pattern(s) can be produced by laser cutting a double sided tape and sticking it in the middle of two PET sheets, so that a fluid channel is formed in a shape as shown in FIG. 1a, and then the fluid can be injected thereto. If a solid dielectric material is used in the dielectric mask, the solid material can be simply cut into a specific shape and then fixed to the base.

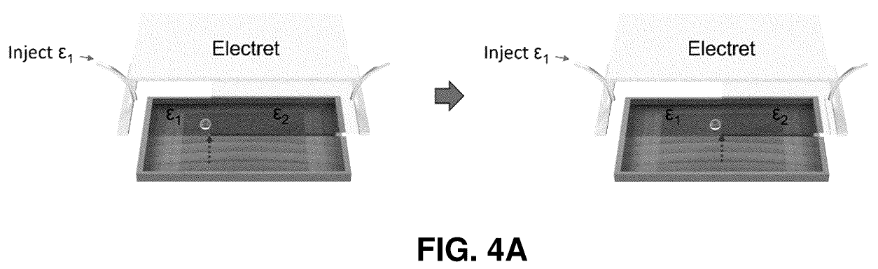

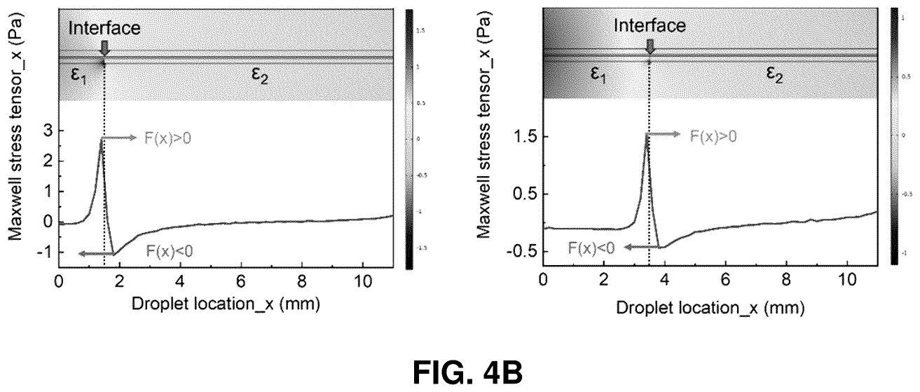

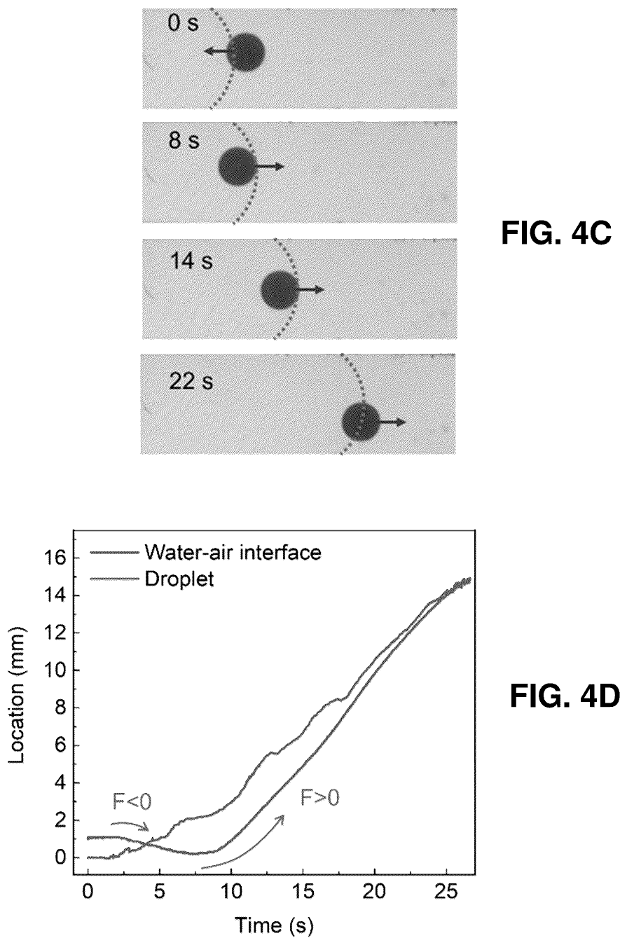

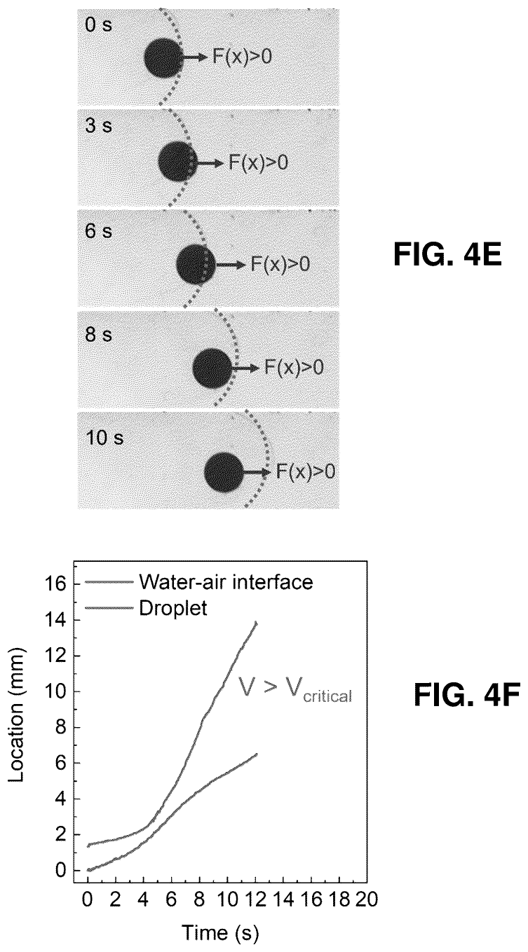

For example, the dielectric mask of the device contains two dielectric materials, where the two dielectric materials have different relative permittivity and are arranged to form one or more interfaces, optionally on a base, such as a PET sheet (see, e.g., FIG. 1a and FIG. 4a). For example, the dielectric mask of the device contains more than two dielectric materials, where a first dielectric material has a relative permittivity that is different from the other dielectric materials, and the first dielectric material is arranged to form one or more interfaces with one or more dielectric materials of the other dielectric materials, optionally on a base, such as a PET sheet. When two or more interfaces between dielectric materials having different permittivity are formed in the dielectric mask, the interfaces may form a desired shape for a particular use, such as the shape of a funnel, a crystal, a bell, etc. (see, e.g., FIG. 3B).

Generally, the dielectric mask can have any suitable size and shape, as long as the interface(s) formed between dielectric materials having different relative permittivity is/are covered by the electrostatic field generated by the electret positioned above the dielectric mask. For example, the length of the interface formed between dielectric materials is larger than the size of the actuated subject(s), such as actuated droplet(s). The dielectric mask can have a shape and/or size that is/are the same as or different from the shape and/or size of the electret. In some forms, the dielectric mask has a shape and/or size that is/are different from the shape and/or size of the electret. In some forms, the dielectric mask has a shape and size that are the same or similar to the shape and size of the electret to facilitate alignment between these two components.

The dielectric mask can be formed from any suitable dielectric materials, as long as two of the dielectric materials in the dielectric mask have different relative permittivity, such as a difference in relative permittivity of at least 1, at least 1.2, at least 1.5, at least 1.8, at least 2.0, or at least 2.2. In some forms, the dielectric mask contains the following pairs of dielectric materials having different relative permittivity: a gas (e.g., air) and a liquid (e.g., water, oils, organic solvent, etc.); a gas (e.g., air) and a solid (e.g., polymers, for example, PET, polyvinyl chloride (PVC), polyethylene (PE), etc., and metals); a liquid (e.g., water, oils, organic solvent, etc.) and a solid (e.g., polymers, for example, PET, polyvinyl chloride (PVC), polyethylene (PE), etc., and metals); two liquids (e.g., water, oils, organic solvent, etc.); or two solids, or a combination thereof.

For example, the dielectric mask contains two dielectric materials, such as water and air; an oil and air; a tape and water; hydrofluoroether and air; paraffin and air; water and paraffin; water and hydrofluoroether; or air and a metal, or a combination thereof.

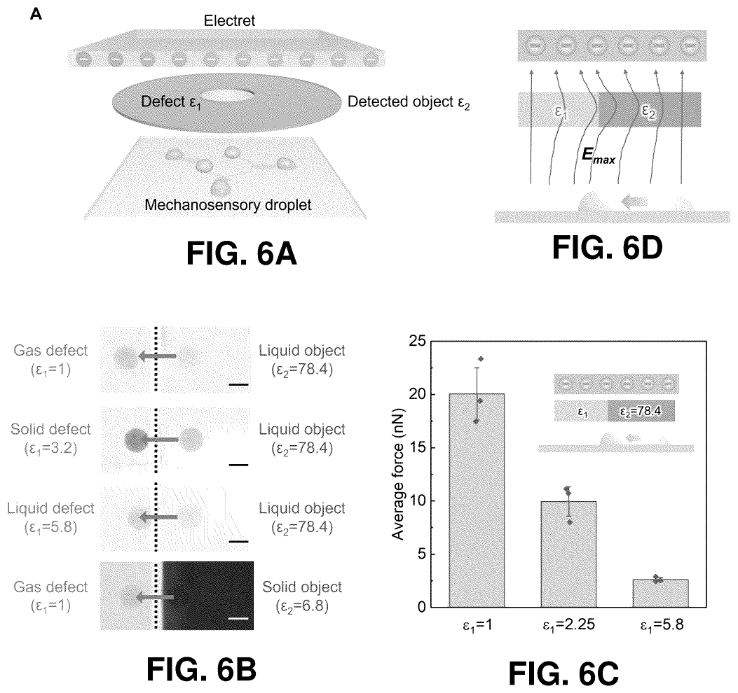

In some forms, the dielectric masks are designed such that it contains solid and air as two dielectric materials. When air is one of the dielectric materials of the dielectric mask, the dielectric mask contains one or more patterns that can hold air, such as a channel or cutout, such that interface(s) between solid or liquid and air are formed on the dielectric mask (see, e.g., FIG. 6a, where the dielectric mask contains a circular cutout, forming a donut shape, allowing air and solid to form a circular interface).

### C. Objects

The device may include one or more objects, such as one or more droplets or one or more solid particles, for visualizing the local maximum of electrostatic field at and/or near the interface(s) of the dielectric mask.

The electrostatic field at the interface of dielectric materials having different relative permittivity in the dielectric mask can be locally enhanced due to the refraction of electrostatic field line. The local maxima of the electrostatic field can then polarize and attracts the one or more objects in the device to move to the local maximum of electrostatic field and get trapped. The trapping of the object(s) can thus indicate the position of the interface(s) between the dielectric materials having different relative permittivity in the dielectric mask, providing a simple way for low-energy interface localization.

The one or more objects are typically placed on a surface of a substrate. When a subject containing the one or more objects is included in the device, the subject is placed beneath the dielectric mask, and the surface of the substrate on which the objects are placed is in parallel and aligns with a surface of the dielectric mask that is opposite to the electret-facing surface of the dielectric mask. The substrate containing the object(s) placed thereon and dielectric mask may be in physical contact with each other, or be kept at a distance from each other. In some forms, the substrate and dielectric mask of the device are kept at a distance from each other, where the distance can range from 0.5 mm to 15 mm, from 0.5 mm to 12 mm, from 0.5 mm to 10 mm, or from 0.5 mm to 5 mm.

The substrate can be formed using any suitable material and in any suitable form, as long as the one or more objects, such as one or more droplets, can move freely on a surface of the substrate. For example, the substrate is in the form of an open channel or a plate, wherein the opening of the open channel or plate faces the second surface of the dielectric mask. For example, the substrate is in the form of a microfluidic device, where the one or more droplets are placed in one or more channels of the microfluidic device, and the channels can be open or closed, preferably, the channels are open channels.

Optionally, the substrate has a coating, such as a coating of HFE oil or a superhydrophobic coating, on which the object(s) are placed. For example, the substrate is an open channel or plate having a coating of HFE oil or a superhydrophobic coating, on which droplet(s) are placed.

When the one or more objects are one or more solid particles, the solid particles can be formed from any suitable materials, such as plastics. The solid particles as object(s) general have an average diameter in the millimeter range.

When the one or more objects are one or more droplets, such droplets can be formed from any suitable liquid. Examples of liquids suitable for forming the one or more droplets in the device include, but are not limited to, inorganic liquids (e.g., water, hydrogen peroxide, acids such as hydrogen chloride, etc.), organic liquids (e.g., ethers such as hydrofluoroether, alcohols such as glycerol, alkanes such as paraffin, esters such as triacetin, etc.), and combinations thereof.

The one or more droplets have a suitable average volume that facilitate movement of the droplets. Generally, the one or more droplets can have an average volume ranging from 0.5 μL to 5 mL, such as from 0.5 μL to 1 mL, from 0.5 μL to 0.5 mL, from 0.5 μL to 50 μL, or from 0.5 μL to 5 μL.

More specific examples of the devices are described in the Examples below.

### II. Methods of Use

The devices described herein can produce a local maximum of electrostatic field at and/or near the interface(s) formed between dielectric materials having different relative permittivity, which then polarizes and attracts one or more objects located nearby, causing the one or more objects to move toward the local maximum of electrostatic field and eventually get trapped. Using the local enhancement of electrostatic field, the device can be used in various applications, such as droplet manipulation and interface localization.

### A. Droplet Manipulation

The devices disclosed herein can be used for manipulating droplets. In some forms, the method for manipulating droplets includes: (i) placing an electrostatic field device disclosed herein on top of one or more droplets. The electrostatic field device includes an electret and a dielectric mask as described above. The electret and dielectric mask are selected to generate a sufficient force to move the droplets toward the local maximum of the electrostatic field, and depend on several factors, such as the droplet type, droplet volume, initial position of droplets, actuation distance, etc. For example, for droplet manipulation, the electret of the device has a charge density of at least-4 μC/m² and/or the dielectric materials have a difference in relative permittivity that is sufficient to produce a local maximum of electrostatic field at and/or near the interface(s), such as ≥1, ≥1.2, ≥1.5, ≥1.8, ≥2.0, or ≥2.2.

Typically, the one or more droplets are placed on a surface of a substrate, such as any one of those described above. For example, the substrate is in the form of a microfluidic device, and wherein the one or more droplets are placed in an open channel or an open plate and can move freely. For example, the substrate is in the form of a microfluidic device, and wherein the one or more droplets are placed in one or more channels of the microfluidic device and can move freely. Preferably, the channels of the microfluidic device are open channels. The surface of the substrate may contain a coating thereon, such as a coating of HFE oil or a superhydrophobic coating, to facilitate free move of the droplets. The electrostatic field device is placed above the substrate such that the substrate surface containing the droplets faces the dielectric mask of the device and is in parallel and aligns with a surface of the dielectric mask.

Following step (i), the one or more droplets are trapped at and/or near one or more locations on the substrate that align with the interfaces formed by two or more dielectric materials having different relative permittivity in the dielectric mask. The dielectric mask used for droplet manipulation typically contains a desired pattern formed by the one or more interfaces, to allow the droplets to move following a desired pattern and get trapped at a desired location.

In some forms, one or more interfaces of the dielectric mask of the device placed above the droplets move continuously, attracting the droplets to move along with the moving interfaces in a desired pattern and/or toward a desired location (see, e.g., FIG. 4a). A continuously moving interface can be achieved by known methods, such as by injecting a second dielectric material (e.g., a gas, such as air) into a channel containing a first dielectric material (e.g., a liquid, such as water), where the first and second dielectric materials have difference relative permittivity. In these forms, the speed of the moving interface(s) is generally ≤1 mm/s, to allow sufficient acceleration of the droplets to the speed of the moving interface(s). This controlled droplet movement can be used to facilitate various automated wet experiments, including but not limited to biomarker detection in body fluids, drug screening, and in vitro cell or bacterial culturing. In some forms, droplets containing reagents, samples, cells, or bacteria can be guided to merge in sequence, allowing specific reactions or analyses. For example, in lithium drug monitoring, a droplet of human body fluid can be successively merged with droplets of masking solution, buffer solution, and a probe solution. The binding of lithium ions with the probe changes the droplet's absorbance, which can then be analyzed to determine the lithium concentration. In some forms, for drug screening applications, droplets containing different candidate drugs can be automatically merged with droplets containing cells, followed by mixing with trypan blue to assess cell viability and identify the most effective therapeutic agent.

In some forms, the method can be used for non-contact sensing in human-machine interface, including but not limited to, non-contact switches in public facilities to prevent the spread of germs, non-contact interaction with machines, and integration with robots to provide situational awareness for perceiving surroundings, avoiding obstacles, or tracking targets. For example, a human finger can function as the dielectric mask. Due to the difference in relative permittivity between the human finger and the surrounding air, a local maximum in the electric field is generated at the edges of the finger. This localized field attracts nearby droplets, causing them to move along with the motion of the finger in a non-contact manner. When a droplet is guided to a specific location, it can serve as a conductor to bridge a gap in a circuit, thereby functioning as a non-contact electrical switch.

Generally, droplet trapping using the disclosed method is fast, i.e., the droplets are trapped at and/or near locations that align with the interfaces within 10 seconds, for example, within 8 seconds, within 5 seconds, or within 2 seconds after placement of the electrostatic field device.

Optionally, the method for manipulating droplets further includes (a) charging the electret before and/or in step (i) to a charge density sufficient to attract the one or more droplets toward locations that align with the one or more interfaces, i.e. the local maximum of electrostatic field.

In some forms, the method for manipulating droplets does not include contacting a surface of the electret with a conductive metal, in particular on the surface that is opposite to the surface of the electret facing the droplets.

### B. Interface Localization

The devices disclosed herein can be used for localizing an interface in an analyte containing dielectric materials having different relative permittivity. In these forms, the analyte acts as the dielectric mask of the device. The interface(s) formed between the dielectric material having different relative permittivity may be stationary or moving.

The analyte can be any suitable object that contains two or more dielectric materials having different permittivity, such as a body part of a human, a film, or a liquid. For example, when the analyte is a human body part, the disclosed method can localize abnormal substances in the human body part, such as injected micro-robots, blood clots in blood vessels, etc. When the analyte is a film, the disclosed method can locate the defective areas in the film, e.g. pores and voids, etc. When the analyte is a liquid, the disclosed method can identify partial phase transitions that occurred in the liquid, e.g., bubbles in thin water layers due to localized heating. When the analyte is a solid, such as an uncharged solid, the disclosed method can locate the defective areas in the solid, e.g. pores, holes, voids, etc.

Generally, the method for localizing interface(s) includes: (i) placing an analyte in the electrostatic field device, where the electrostatic field device includes an electret and one or more objects placed on a surface of a substrate, as described above.

The analyte is placed between the electret and the substrate such that a first surface of the analyte is in parallel and aligns with the substrate-facing surface of the electret, and a second surface of the analyte that is opposite to the first surface of the analyte is in parallel and aligns with the electret-facing surface of the substrate.

Following step (i), the one or more objects are trapped at one or more locations on the surface of the substrate that aligns with one or more interfaces in the analyte, and thereby indicate the locations of the one or more interfaces.

Generally, interface localization of an analyte using the disclosed method is fast, i.e., the objects are moved and trapped at and/or near locations that align with the interfaces within 10 seconds, for example, within 8 seconds, within 5 seconds, or within 2 seconds after placement of the electrostatic field device.

Optionally, the method for localizing interfaces in an analyte further includes: (a) charging the electret before and/or in step (i) to a charge density sufficient to attract the one or more objects toward locations that align with the one or more interfaces, i.e. the local maximum of electrostatic field.

Optionally, the method for localizing interfaces in an analyte can be used to localize “buried” interfaces or defects in the analyte. In forms where the method is for localizing “buried” interfaces or defects in the analyte, the device can further include one or more barriers positioned on one or both sides of the analyte as described above. For example, two barriers are positioned on two sides of the dielectric mask, where a first barrier is on top of the dielectric mask and a second barrier is beneath the dielectric mask.

The disclosed methods and devices can be further understood through the following enumerated paragraphs.
Paragraph 1. An electrostatic field device comprising:
   (a) an electret; and
   (b) a dielectric mask comprising two or more dielectric materials,
   wherein at least two of the two or more dielectric materials have different relative permittivity,
   wherein the at least two dielectric materials having different relative permittivity are arranged such that one or more interfaces are formed therebetween, and
   wherein a first surface of the dielectric mask is in parallel and optionally aligns with at least a portion of a first surface of the electret.
Paragraph 2. The electrostatic filed device of paragraph 1, further comprising
   (c) one or more objects placed on a first surface of a substrate, optionally wherein the one or more objects are one or more droplets,
   wherein a second surface of the dielectric mask that is opposite to the first surface of the dielectric mask is in parallel with and aligns with the first surface of the substrate, and
   optionally wherein the dielectric mask has a length that is longer than the length of the substrate.
Paragraph 3. The electrostatic filed device of paragraph 2, wherein the substrate is in the form of an open channel or a plate, wherein the opening of the open channel or plate faces the second surface of the dielectric mask.
Paragraph 4. The electrostatic field device of any one of paragraphs 1-3, wherein the difference in relative permittivity of the at least two dielectric materials having different relative permittivity is sufficient to produce a local maximum of electrostatic field at and/or near the interface(s).
Paragraph 5. The electrostatic field device of any one of paragraphs 1-4, wherein the at least two dielectric materials having different relative permittivity comprise: a gas (e.g., air) and a liquid (e.g., water, oils, organic solvent, etc.); a gas (e.g., air) and a solid (e.g., polymers, metals, etc.); a liquid (e.g., water, oils, organic solvent, etc.) and a solid (e.g., polymers, metals, etc.); two liquids (e.g., water, oils, organic solvent, etc.); or two solids; or a combination thereof.
Paragraph 6. The electrostatic field device of any one of paragraphs 1-5, wherein the at least two dielectric materials having different relative permittivity comprise: water and air; hydrofluoroether and air; paraffin and air; water and paraffin; water and hydrofluoroether; or air and a metal, or a combination thereof.
Paragraph 7. The electrostatic field device of any one of paragraphs 1-6, wherein the at least two dielectric materials having different relative permittivity are arranged such that two or more interfaces are formed therebetween.
Paragraph 8. The electrostatic field device of paragraph 7, wherein the two or more interfaces form a shape.
Paragraph 9. The electrostatic field device of any one of paragraphs 1-8, wherein the electret comprises silicon dioxide, or a polymer, or a combination thereof.
Paragraph 10. The electrostatic field device of any one of paragraphs 1-9, wherein the electret has a charge density of at least −4 μC/m².
Paragraph 11. The electrostatic field device of any one of paragraphs 2-10, wherein the one or more objects are one or more plastic particles, and/or one or more droplets formed by an inorganic liquid (e.g., water, hydrogen peroxide, acids such as hydrogen chloride, etc.) or an organic liquid (e.g., ethers such as hydrofluoroether, alcohols such as glycerol, alkanes such as paraffin, esters such as triacetin, etc.).
Paragraph 12. The electrostatic field device of paragraph 11, wherein the one or more droplets have an average volume ranging from 0.5 μL to 5 mL.
Paragraph 13. A method of trapping one or more droplets, comprising:
   (i) placing the electrostatic field device of any one of paragraphs 1 and 4-10 on top of the one or more droplets,
   wherein following step (i), the one or more droplets are trapped at one or more locations that align with the one or more interfaces.
Paragraph 14. The method of paragraph 13, wherein the one or more droplets are placed on a surface of a substrate.
Paragraph 15. The method of paragraph 14, wherein the substrate is in the form of a microfluidic device, and wherein the one or more droplets are placed in one or more channels of the microfluidic device.
Paragraph 16. The method of any one of paragraphs 13-15, wherein the one or more droplets are trapped at the location that aligns with the one or more interfaces within 10 seconds, within 5 seconds, or within 2 seconds following placement of the electrostatic field device.
Paragraph 17. The method of any one of paragraphs 13-16, further comprising (a) charging the electret before and/or in step (i) to a charge density sufficient to attract the one or more droplets toward the one or more locations that align with the one or more interfaces.
Paragraph 18. A method of locating one or more interfaces formed between two or more dielectric materials in an analyte, comprising:
   (i) placing the analyte comprising the two or more dielectric materials in an electrostatic field device,
   wherein the electrostatic field device comprises an electret and one or more objects placed on a first surface of a substrate, wherein the first surface of the substrate is in parallel and aligns with a first surface of the electret,
   wherein the analyte is placed between the electret and the substrate such that a first surface of the analyte is in parallel and aligns with the first surface of the electret, and a second surface of the analyte that is opposite to the first surface of the analyte is in parallel and aligns with the first surface of the substrate, and
   wherein following step (i), the one or more objects are trapped at one or more locations that align with the one or more interfaces and indicate the location of the one or more interfaces in the analyte.
Paragraph 19. The method of paragraph 18, wherein the one or more droplets are trapped at the one or more interfaces within 10 seconds, within 5 seconds, or within 2 seconds following placement of the electrostatic field device.
Paragraph 20. The method of paragraph 18 or 19, wherein the analyte is a body part of a human, a film, or a liquid.
Paragraph 21. The method of any one of paragraphs 18-20, further comprising (a) charging the electret before and/or in step (i) to a charge density sufficient to attract the one or more objects toward the one or more locations that align with the one or more interfaces.
Paragraph 22. The electrostatic field device of any one of paragraphs 18-21, wherein the electret comprises silicon dioxide, or a polymer, or a combination thereof.
Paragraph 23. The method of any one of paragraphs 18-22, wherein the one or more objects are one or more plastic particles, and/or one or more droplets formed by an inorganic liquid (e.g., water, hydrogen peroxide, acids such as hydrogen chloride, etc.) or an organic liquid (e.g., ethers such as hydrofluoroether, alcohols such as glycerol, alkanes such as paraffin, esters such as triacetin, etc.).
Paragraph 24. The method of paragraph 23, wherein the one or more droplets have an average volume ranging from 0.5 μL to 5 mL.
Paragraph 25. The electrostatic field device of any one of paragraphs 5-12, wherein the solid is an uncharged solid.
Paragraph 26. The method of any one of paragraphs 18-24, wherein the analyte comprises buried interfaces.

### EXAMPLES

### Example 1. Devices for Droplet Trapping/Actuation and Interface Localization Based on Interfacial Enhancement of Electrostatic Field

### Materials and Methods

HFE-7500 (Novec Engineered Fluid, 3 M) was selected as the oil substrate to support the floating droplet acting as the mechanosensory structure. DI water, HCl (Aladdin), H₂O₂ (QuantaRed Stable Peroxide Solution, Thermofisher), Paraffin (Aladdin), Glycerol (Sigma-Aldrich), Triacetin (Aladdin) was used as the droplet that served as the mechanosensory structure, respectively. DI water was used for most of the experiments unless otherwise specified. Methylene blue (TCI), oil red O (C.1.26125, Aladdin), or rhodamine B (Aladdin) were added in the droplet to visualize the movement of transparent droplets in some optical image demonstrations.

### Fabrication of the Demonstrated Device

The electret was made of PTFE charged by contact electrification with copper. To fabricate the dielectric chip used for droplet trapping and actuation, two pieces of transparent polyethylene terephthalate (PET) film sheets (150 μm in thickness) were assembled by one layer of double-sided tape (170 μm in thickness, 3M). Laser cutting was employed to create fluidic channels within the adhesive layer, with inlet/outlet ports patterned on the PET sheets for liquid/gas injection. Different liquids or air could be injected in each channel, respectively, forming interface with permittivity difference on both sides. To fabricate the detected object used for multiple defects detection, double-sided tape was cut into square pieces and placed at designated positions between PET sheets. The rest between the PET sheet was filled with water, forming a liquid object with multiple buried solid defects in it.

### Characterization of the Device's Performance

The charged PTFE electret sheet was placed above the detected object in a non-contact way. The quantity of charge on the electret was measured by positioning it inside a Faraday cup, which was linked to a programmable electrometer (model 6514 from Keithley Instruments) set to the charge measurement mode. Droplet motion tracking was implemented through bottom-view optical recording, with trajectory data analyzed via the Tracker software package to extract positional coordinates and instantaneous velocity vectors. To calculate the average force applied on droplet during its movement, the average acceleration of droplet from its initial position (10 mm away from the interface between object and surroundings) until its first pass through the interface was calculated and then multiplied by the droplet mass.

### Results

### Working Principle of the Interfacial Enhancement of Electrostatic Field

A sustainable method to achieve droplet trapping and interface localization without high energy cost has been developed (FIG. 1A). The method is based on the local enhancement of electrostatic field at the interface of two materials with different permittivity. An electret carries intrinsic electrostatic charges are used to generate an approximately uniform electrostatic field without external power supply. A thin layer of dielectric mask is placed beneath the electret, in which two materials with different permittivity (ε₂>ε₁) forms interfaces. Different polarized charges existed in ε₁ and ε₂, and distorted the distribution of electrostatic field severely (FIG. 1b). Therefore, the presence of an interface made of two materials with different permittivity locally enhanced the electric field strength and generated a local maximum Eₘₐₓ at the intersection of ε₁ and ε₂.

The principle of interfacial enhancement of the electrostatic field was confirmed by both simulation and practical potential measurements (FIG. 1C). According to the simulation results, the component of electric field strength in x-direction showed a localized growth near the interface. Meanwhile, the practical scanning results of the electrostatic potential showed that the variation rate of electrical potential near the interface was locally maximum along the x-direction, consistent with the simulation results. The measured location of the maximum value deviated slightly from the simulation results, as experimental environment can affect the practical electrostatic potential distribution. Despite this slight deviation, the conclusion that the electrostatic field gets locally enhanced near the interface between ε₁ and ε₂ stands.

Similar to the principle of dielectrophoresis, dielectric objects are polarized under an inhomogeneous electrostatic field and subjected to a force directed towards the maximum value of the field strength:

$$F = 4 {πε}_{m} {r}^{3} \frac{{ε}_{d} - {ε}_{m}}{{ε}_{d} + 2 {ε}_{m}} ( E \cdot ∇ ) E \qquad ( 1 )$$

where r is the radius of the dielectric object and is assumed much smaller than the scale of the field nonuniformity, εₘ and ε_{d} is the permittivity of the surrounding medium and droplet, respectively, E is the strength of electric field. Therefore, the non-uniform electric field resulting from the interfacial enhancement effect can also function to attract dielectric objects such as liquid droplets (FIG. 1D). By substituting the simulated electric field strength E, the maxwell stress tensor applied to the droplets at different locations can be calculated (FIG. 1E). As shown in FIG. 1E, droplets on both sides of the interface are subjected to forces pointing towards the interface and eventually get trapped at the force equilibrium point (i.e., F=0) near the interface. The trapping of the droplet can also reversely indicate the position of the interface between the two media, providing a function of passive interface localization.

### Droplet Trapping Based on Interfacial Enhancement of Electrostatic Field

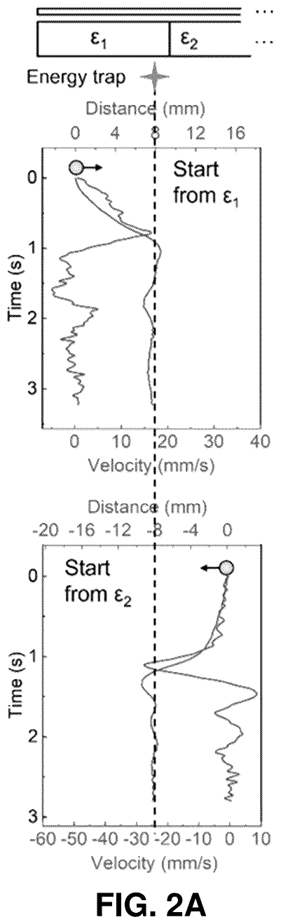

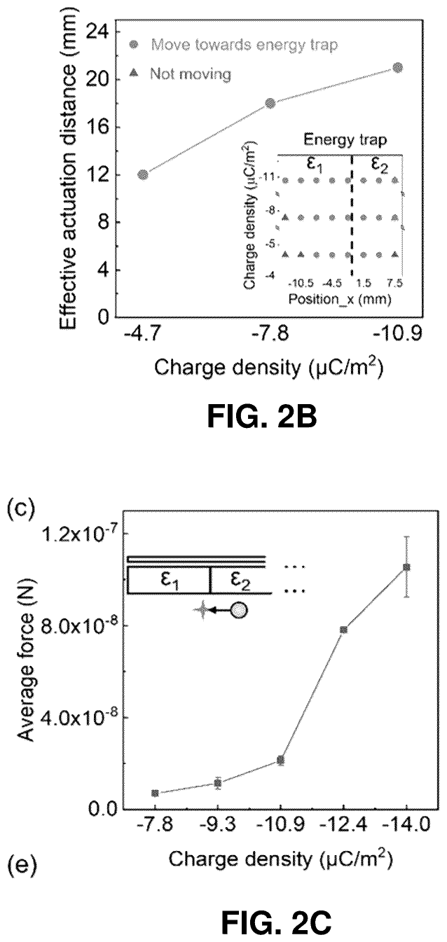

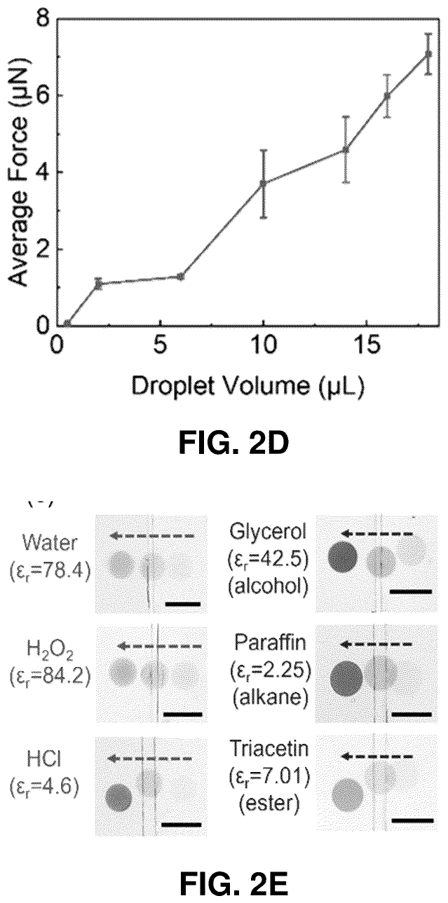

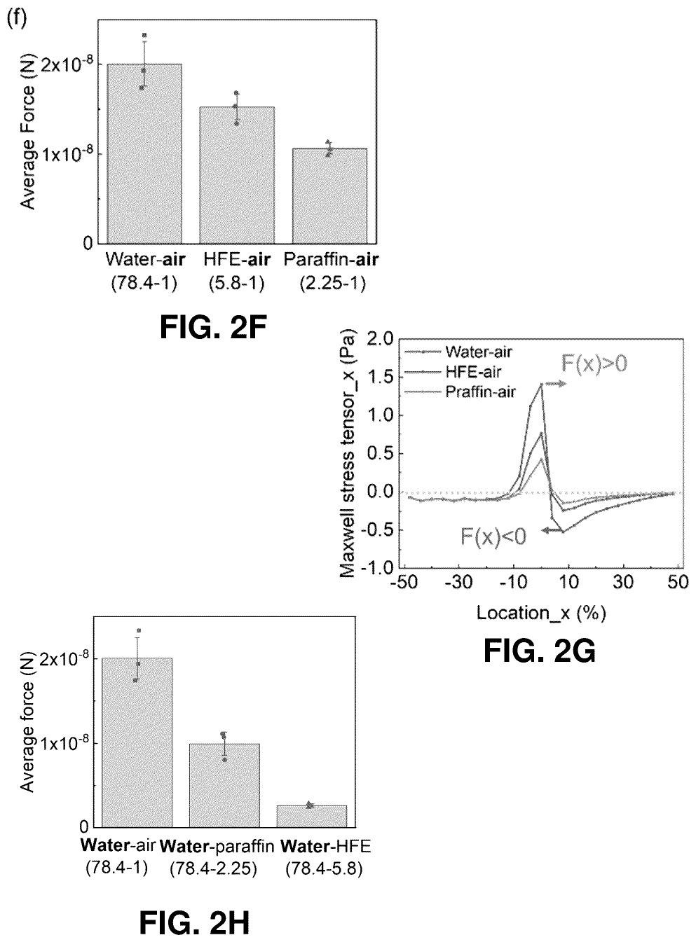

Based on the understanding of local enhancement of the electrostatic field at the interface, droplets located on either side of the interface can be attracted toward the point of maximum field strength near the interface in a damped oscillation (FIG. 2A). This damped oscillation lasts for about four cycles, after which the droplets are trapped at the energy trap near the interface. The maximum velocity of droplet during the whole process can reach nearly 20 mm/s.

The effect of different parameters on the droplet actuation process was also studied. By increasing the charge density of electret, the effective actuation distance of droplets (FIG. 2B) and the average actuation force on the droplets (FIG. 2C) increased. The electrostatic polarization-based droplet actuation has a good generalization for the droplet size as well as the liquid type. As the droplet size increased, the average driving force applied to the droplet increased linearly (FIG. 2D). This droplet actuation was validated for several common inorganic and organic liquids, including liquids with relative permittivity ranging from 2.25 to 84.2 (FIG. 2E).

Different interface combinations were studied, including water-air, HFE-air, paraffin-air, water-HFE, and water-paraffin (FIG. 2F and FIG. 2G). The experimental results showed that as the difference between the permittivity of media on both sides decreased, the attraction force applied on droplets also decreased, consistent with the simulation results (FIG. 2H). This result also demonstrated that the interfacial enhancement of electrostatic fields-based droplet actuation does not have a specific limitation on the type of interface. Further, difference interfaces can affect the droplet actuation process, demonstrating the potential for interface localization as well as distinguishing interface species.

### Multiple Droplets Trapping

The droplet actuation based on interfacial enhancement of the electrostatic field can be applied to multiple droplets simultaneously. By designing dielectric masks with multiple interfaces, multiple local maxima of electrostatic field can be generated spatially. Therefore, multiple droplets can be captured individually by the nearest local maximum point and form a particular pattern.

Three dielectric masks were produced, where interfacial enhancement of electrostatic field happens near each interface, thus providing a platform for multiple droplet trapping. As shown in FIG. 3B, location of local maxima of the generated electrostatic field form the shape of a funnel, a crystal, and a bell, respectively. Six droplets were first placed in the pattern of a shield, then different dielectric masks were utilized in sequence, which caused the droplets to transform according to the shape of the generated electrostatic field (FIG. 3C).

### Active Droplet Actuation and Localization of the Moving Interface

In addition to passive droplet trapping, active droplet actuation can be realized based on movable interfaces. Based on the flexibility of fluid's interfaces, a microfluidic chip full of water (ε₂) was designed to generate a movable interface by injecting air (ε₁) therein (FIG. 4A). Simulation results of the electric field strength distribution showed that a localized field maximum occurred near the air-water movable interface, which generated a force on droplet pointing towards the interface (FIG. 4B). When the interface moved slowly, it can be considered as a quasi-static process, and the droplet can be trapped by the interface under the Maxwell stress tensor and move with it.

The results showed that when the water-air interface moved forward at a speed of about 0.7 mm/s, the droplets located in front of the interface's moving direction first moved backward until captured by the interface (FIG. 4C and FIG. 4D). The applied forward actuation force on the droplet was greater than the resistance, gradually accelerating the droplet and shortening the distance between the droplet and the interface, achieving active actuation of the droplet. The method can also be used to locate a moving interface. However, when the interface moved too fast, the forward actuation force provided was not sufficient to accelerate the droplet to the speed of the moving interface. As the interface moved rapidly forward, the distance between the interface and the droplets gradually increased, and the forward actuation force exerted by the interface on the droplets decreased, thereby decelerating the droplets to a stop (FIG. 4E and FIG. 4F). Thus, to achieve active actuation of droplets or the localization of a moving interface, the speed of the interface needs to be controlled within a suitable range.

### Sensing of General Uncharged Objects in the Air

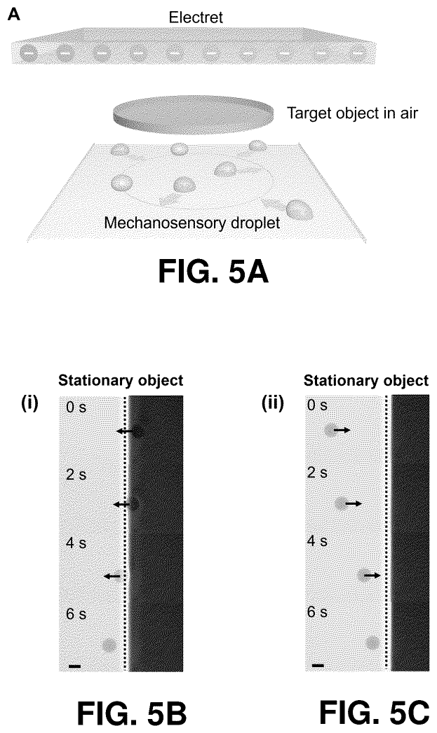

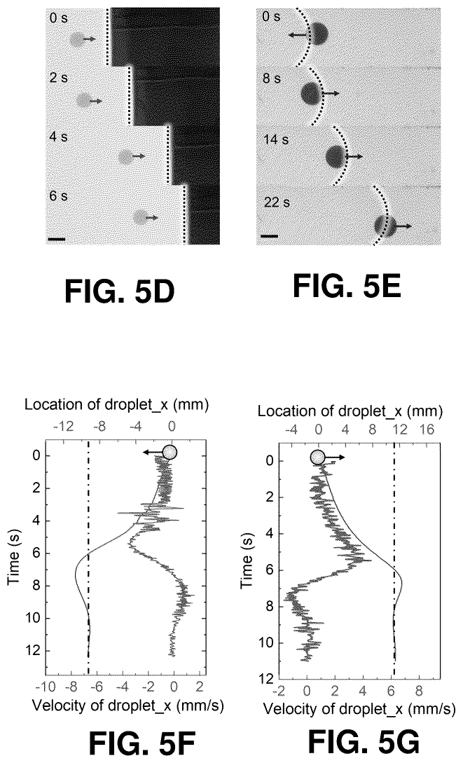

The disclosed device located the interface of the target object since the actuated droplets stop at the projection of the interface between the object and the surroundings. To verify this inference, the dielectric mask in the device was replaced with a target object in air. An experimental platform containing a negatively charged Polytetrafluoroethylene (PTFE) electret, a water droplet floating on the surface of heavy oil, and an uncharged target object was constructed, while all three components are held out of contact with each other in the air (FIG. 5A). To support this setup, a two-layer shelf was constructed in the experiment to hold the electret and the target object at different heights above the table, while the droplets were placed on the table surface below. By placing a stationary object beneath the electret and observing from the bottom angle, the results showed that the mechanosensory droplets originally located beneath either the target object or the air surroundings was subjected to forces pointing toward the interface, attracted toward the point of Eₘₐₓ near the interface in a damped oscillation (FIGS. 5B, 5C, 5F, and 5G). This damped oscillation lasted for around two cycles, after which the droplet stopped near the projection of the interface. In addition to stationary objects, the function of the device was verified for locating moving objects. The results showed that droplets dynamically followed the boundary of a moving object, regardless of whether it was a solid or a liquid object (FIG. 5D-5E).

### Locating Defects in Objects

The device was also applicable to locate defects in objects due to the permittivity difference between the bulk of the object (ε₂) and the defect area (ε₁) (FIG. 6A). The experimental results showed that the droplets located the interface between the bulk of the object and the defect area, including but not limited to locating gas defects in liquid objects, solid defects in liquid objects, liquid defects in liquid objects, and gas defects in solid objects (FIG. 6B). The larger the difference between ε₁ and ε₂, the larger the actuation force applied on the mechanosensory droplets (FIG. 6C). Therefore, electrostatic field device was proven to locate general defects in objects, regardless of their phase of matter.

Based on the results for detecting defects, the disclosed device was tested for detecting multiple defects simultaneously. Considering that electrolocation can cross barriers and locate hidden objects, the device was applied for detecting buried defects by adding barriers on either side of the detected object: three detected objects (ε₂) were prepared and sandwiched by two barriers, respectively, while multiple buried defects made of different materials (ε₁) were placed inside of them in various patterns (FIG. 3A). When inserting the detected object as shown in FIG. 6a, multiple Eₘₐₓ were generated at the interface of each defect in both x- and y-directions simultaneously (FIG. 3B). Therefore, employed multiple mechanosensory droplets, provided the device the ability to detect multiple defects in one object simultaneously. By placing the detected objects sequentially in the device, continuous defect detection became achievable. This experimental setup demonstrated the device's ability to detect buried defects; in practical applications, when a defect is located inside a solid object, the outer layer of that object itself can function as the barrier, eliminating the need to manually add external barriers.

The first-detected object was placed inside the device and caused droplets (D1-D6) to be attracted to the buried defect, forming a triangle pattern identical to the defect arrangement when observed from the bottom angle (FIG. 3C). The x- and y-coordinates of droplets overlapped with the coordinates of all defects after stabilization, which located the buried defects in the detected object. When the first detected object is removed, droplets move mildly due to capillary forces. However, after a new object was fixed in the device, all mechanosensory droplets moved toward the updated positions of the defects and stabilized, demonstrating the system's sequential defect detection capability (FIGS. 3D and 3E). Through the continuous placement of different objects inside of the device, mechanosensory droplets successfully located all buried defects in each object.

The experimental results demonstrated that the proposed device was used to locate multiple buried defects simultaneously, and sequential defect detection was achieved through continuous replacement of the detected objects. The ability of the device to locate general objects and defects in objects in the non-conductive surroundings showed the device's capability for applications such as industrial defect detection, medical diagnostics, and environment monitoring.

Unless defined otherwise, all technical and scientific terms used herein have the same meanings as commonly understood by one of skill in the art to which the disclosed invention belongs. Publications cited herein and the materials for which they are cited are specifically incorporated by reference. Further, unless otherwise indicated, use of the expression “wt %” refers to “wt/wt %.”

Those skilled in the art will recognize, or be able to ascertain using no more than routine experimentation, many equivalents to the specific embodiments of the invention described herein. Such equivalents are intended to be encompassed by the following claims.

We claim:

1. An electrostatic field device comprising:
(a) an electret; and
(b) a dielectric mask comprising two or more dielectric materials,
wherein at least two of the two or more dielectric materials have different relative permittivity,
wherein the at least two dielectric materials having different relative permittivity are arranged such that one or more interfaces are formed therebetween, and
wherein a first surface of the dielectric mask is in parallel and optionally aligns with at least a portion of a first surface of the electret.

2. The electrostatic filed device of claim 1, further comprising
(c) one or more objects placed on a first surface of a substrate, optionally wherein the one or more objects are one or more droplets,
wherein a second surface of the dielectric mask that is opposite to the first surface of the dielectric mask is in parallel with and aligns with the first surface of the substrate, and
optionally wherein the dielectric mask has a length that is longer than the length of the substrate.

3. The electrostatic filed device of claim 2, wherein the substrate is in the form of an open channel or a plate, wherein the opening of the open channel or plate faces the second surface of the dielectric mask.

4. The electrostatic field device of claim 1, wherein the difference in relative permittivity of the at least two dielectric materials having different relative permittivity is sufficient to produce a local maximum of electrostatic field at and/or near the interface(s).

5. The electrostatic field device of claim 1, wherein the at least two dielectric materials having different relative permittivity comprise: a gas (e.g., air) and a liquid (e.g., water, oils, organic solvent, etc.); a gas (e.g., air) and a solid (e.g., polymers, metals, etc.); a liquid (e.g., water, oils, organic solvent, etc.) and a solid (e.g., polymers, metals, etc.); two liquids (e.g., water, oils, organic solvent, etc.); or two solids; or a combination thereof,
optionally water and air; hydrofluoroether and air; paraffin and air; water and paraffin; water and hydrofluoroether; or air and a metal, or a combination thereof.

6. The electrostatic field device of claim 1, wherein the at least two dielectric materials having different relative permittivity are arranged such that two or more interfaces are formed therebetween.

7. The electrostatic field device of claim 6, wherein the two or more interfaces form a shape.

8. The electrostatic field device of claim 1, wherein the electret:
(a) comprises silicon dioxide, or a polymer, or a combination thereof; or
(b) has a charge density of at least-4 μC/m²; or
(c) a combination thereof.

9. The electrostatic field device of claim 2, wherein the one or more objects are one or more plastic particles, and/or one or more droplets formed by an inorganic liquid (e.g., water, hydrogen peroxide, acids such as hydrogen chloride, etc.) or an organic liquid (e.g., ethers such as hydrofluoroether, alcohols such as glycerol, alkanes such as paraffin, esters such as triacetin, etc.).

10. The electrostatic field device of claim 9, wherein the one or more droplets have an average volume ranging from 0.5 μL to 5 mL.

11. A method of trapping one or more droplets, comprising:
(i) placing the electrostatic field device of claim 1 on top of the one or more droplets,
wherein following step (i), the one or more droplets are trapped at one or more locations that align with the one or more interfaces.

12. The method of claim 11, wherein the one or more droplets are placed on a surface of a substrate.

13. The method of claim 12, wherein the substrate is in the form of a microfluidic device, and wherein the one or more droplets are placed in one or more channels of the microfluidic device.

14. The method of claim 11, wherein the one or more droplets are trapped at the location that aligns with the one or more interfaces within 10 seconds, within 5 seconds, or within 2 seconds following placement of the electrostatic field device.

15. The method of claim 11, further comprising (a) charging the electret before and/or in step (i) to a charge density sufficient to attract the one or more droplets toward the one or more locations that align with the one or more interfaces.

16. A method of locating one or more interfaces formed between two or more dielectric materials in an analyte, comprising:
(i) placing the analyte comprising the two or more dielectric materials in an electrostatic field device, optionally the analyte comprises one or more buried interface(s),
wherein the electrostatic field device comprises an electret and one or more objects placed on a first surface of a substrate, wherein the first surface of the substrate is in parallel and aligns with a first surface of the electret,
wherein the analyte is placed between the electret and the substrate such that a first surface of the analyte is in parallel and aligns with the first surface of the electret, and a second surface of the analyte that is opposite to the first surface of the analyte is in parallel and aligns with the first surface of the substrate, and
wherein following step (i), the one or more objects are trapped at one or more locations that align with the one or more interfaces and indicate the location of the one or more interfaces in the analyte.

17. The method of claim 16, wherein the one or more droplets are trapped at the one or more interfaces within 10 seconds, within 5 seconds, or within 2 seconds following placement of the electrostatic field device.

18. The method of claim 16, wherein the analyte is a body part of a human, a film, or a liquid.

19. The method of claim 16, further comprising (a) charging the electret before and/or in step (i) to a charge density sufficient to attract the one or more objects toward the one or more locations that align with the one or more interfaces.

20. The method claim 16, wherein the one or more objects are one or more plastic particles, and/or one or more droplets formed by an inorganic liquid (e.g., water, hydrogen peroxide, acids such as hydrogen chloride, etc.) or an organic liquid (e.g., ethers such as hydrofluoroether, alcohols such as glycerol, alkanes such as paraffin, esters such as triacetin, etc.),
Optionally wherein the one or more droplets have an average volume ranging from 0.5 μL to 5 mL.
